(19) United States
(12) Patent Application Publication
(10) Pub. No.: US 2010/0059544 A1
(43) Pub. Date: Mar. 11, 2010

(54) KEG ENVELOPING A CONTAINER FOR CONTAINING A PRESSURIZED BEVERAGE

(75) Inventors: Jacob Dijkstra, Drachten (NL); Paulus Cornelis Duineveld, Drachten (NL); Joldert Maria Boersma, Drachten (NL); Andries Bron, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,154

(22) PCT Filed: Sep. 12, 2007
(86) PCT No.: PCT/IB07/53668

§ 371 Date: Mar. 13, 2009

(30) Foreign Application Priority Data
Sep. 18, 2006 (EP) 06120822.9

(51) Int. Cl. B65D 35/28; B65D 35/56; B67D 7/60; B65D 37/00

(52) U.S. Cl. 222/95; 222/105; 222/386.5; 222/206

(57) ABSTRACT

A keg enveloping a container (8) for containing a beverage and means for deforming the container (8) in order to drive the beverage out of the keg (1). The container (8) comprises two substantial rigid walls (13,14), which walls are mutually connected by a flexible wall (15). The flexible wall (15) is shaped as a bellows. Said means can move the two rigid walls (13,14) towards each other, so that the distance between the two rigid walls (13,14) varies. The material of the container (8) comprises preferably a metal layer or is made of metal.

### FIELD OF THE INVENTION

The invention is related to a keg enveloping a container for containing a beverage and means for deforming the container in order to drive the beverage out of the keg. Thereby, the container is completely filled with the beverage, and the quantity of the beverage in the container, i.e. the content of the container, can be varied by deforming the container.

### BACKGROUND OF THE INVENTION

The container may contain beer, but the beverage can also be any other beverage. The keg can be used as a beverage dispenser, whereby the beverage can be dispensed directly through a tap that is mounted on the keg. The keg can also be a replaceable beverage holder in a beverage dispensing apparatus, for example, a domestic beer dispensing apparatus. Such domestic beer dispensing apparatus is disclosed in WO-A-2004/051163.

Publication WO-A-2005/113371 describes a keg for storing beer, provided with a container being a deformable bag made of flexible plastic material, whereby the means for driving the beverage out of the keg comprise pressurized air inside the keg and outside the plastic bag. The material of the container has to be relative thin in order to obtain the flexibility that is required for deforming the container. It is difficult and/or expensive to make such thin flexible material completely gas-tight, so that in practice air will pass through the material of the container, and therefore the beverage inside the container can only be stored for a limited time.

### SUMMARY OF THE INVENTION

An object of the invention is a keg enveloping a container for containing a beverage and comprising means for deforming the container, whereby the material of the container may have a relative large thickness, so that it can easily be made more gas-tight.

Another object of the invention is a keg enveloping a container for containing a beverage and comprising means for deforming the container, whereby at least a part of the pressure inside the container is caused by the elasticity of the material of the container.

To accomplish with one or both of these objects, the container comprises two substantial rigid walls, which walls are mutually connected by a flexible wall, whereby the flexible wall is shaped as a bellows, and whereby said means can move the two rigid walls towards each other, so that the distance between the two rigid walls varies. With the expression bellows is meant any wall that is made of sheet material, whereby the length of the sheet material is substantial larger than the largest distance between the two rigid walls, being the maximal length of the wall. Thereby, the wall can be bended or folded in a zig-zag fashion, whereby the material can be relatively thick and curved (folded) in the corners.

Preferably, the material of the container comprises a metal layer or is metal, so that the container is completely gas-tight, whereby the material of the bellows-shaped wall of the container has sufficient flexibility for the required deformation.

A collapsible and expandable container for a liquid having a side wall that is shaped as a bellows is for example described in US-A-2006/0180614. The container has a rectangular cross section, and the distance between the two end walls can vary, whereby the length of the side wall varies accordingly. A container whereby the bellows has a circular cross section is described in US-A-2006/0110210.

In a preferred embodiment, the maximum distance between the two rigid walls is at least ten times, preferably more than fifteen times, the minimum distance between the rigid walls. Thereby, the container may contain, for example, 6 liter beverage when it is completely filled, and only a small quantity of the beverage remains in the container after the container is emptied. That quantity can be further reduced by an appropriate shape of the two rigid walls, and/or by inserting a piece of solid material in the container.

In a preferred embodiment, the two rigid walls are pulled towards each other by means of the elasticity of the material of the flexible wall. Thereby, the container has its smallest content when there are no forces exerted on the material of the container. When the container is filled with beverage, the material of the container will be deformed, whereby the elasticity of the material results in forces that pressurize the beverage in the container. So, the bellows provides for a certain pressure in the beverage, which pressure may be enough to drive the beverage out of the container when the tap of the keg or the beverage dispensing apparatus is open. In case the forces are not sufficient for driving out the beverage, other drive means can be additionally used.

In case the two rigid walls are pulled towards each other by means of the elasticity of the material of the flexible wall, the beverage in the container is always under pressure. That can be an important advantage of the keg, because such continuous pressure may be desired when storing the beverage. Thereby, such pressure is present without the functioning of other pressurizing means in or outside the keg.

The two rigid walls can be mutually connected by a straight edge of both walls, whereby the two rigid walls can hinge with respect to each other. However, in a preferred embodiment, the two rigid walls are substantial parallel, whereby the complete edge of each rigid wall is connected with the bellows-shaped side wall of the container. Thereby, preferably, in sectional view, the side wall has substantially the shape of an equilateral polygon. This is an appropriate shape of the container in order to fit in a substantial cylindrical keg.

The means for deforming the container in order to drive the beverage out of the keg can be the elasticity of the material of the container and/or other means. In a preferred embodiment such other means comprise a flexible container for containing a medium, such as gas or fluid, inside the keg, but outside the container, which medium container can be pressurized in order to push the two rigid walls towards each other. A pump for pressurizing the flexible medium container can be present in the beverage dispensing apparatus in which the keg can be placed.

In a preferred embodiment, the means for deforming the container comprise mechanical means inside the keg for moving the two rigid walls towards each other. Such mechanical means can be a spindle or, preferably, springs, which springs may be located inside or outside the container. By making use of mechanical springs, the beverage in the container can be held under pressure during the dispensing of the beverage, without any device outside the keg. Thereby, the keg can be provided with a tap and the beverage can be dispensed through that tap.

### BRIEF DESCRIPTION OF THE DRAWINGS

The invention will now be further elucidated by means of a description of four embodiments of a keg enveloping a container for containing beer and means for deforming the container in order to drive the beer out of the keg, whereby reference is made to the drawing comprising diagrammatic figures, whereby:

FIG. 1 shows a keg according to the prior art;

FIGS. 2A and 2B show the principle of a container according to the invention;

FIGS. 3A and 3B show the first embodiment of the keg;

FIGS. 4A and 4B show the second embodiment of the keg;

FIG. 5 shows the third embodiment of the keg; and

FIG. 6 shows the fourth embodiment of the keg.

### DETAILED DESCRIPTION OF THE EMBODIMENTS

The figures are only schematic and diagrammatic representations, showing only parts of the keg that are relevant for the elucidation of the invention. When describing the different embodiments, similar parts are indicated in the figures with the same reference numerals.

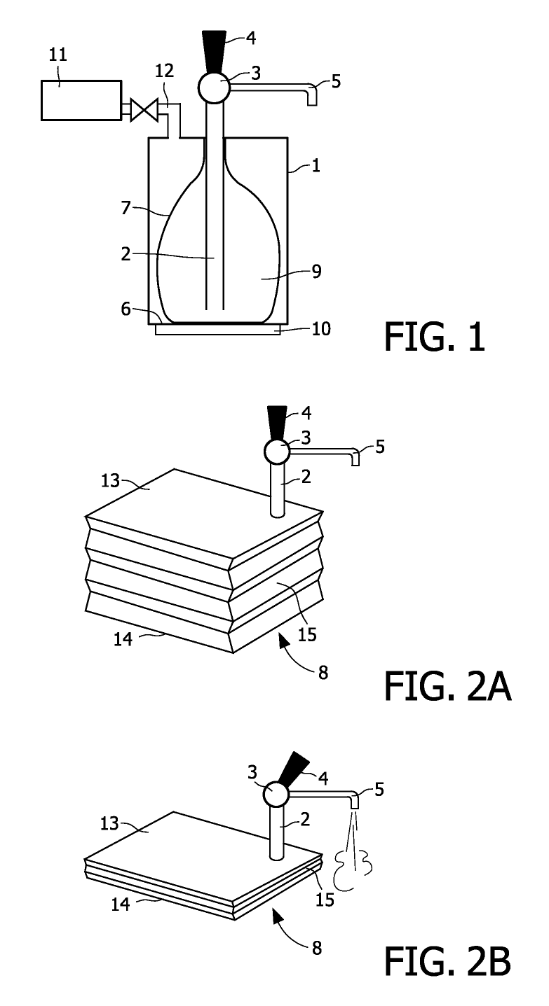

FIG. 1 shows a metal keg 1 for containing beer according to the prior art. The keg 1 has a substantial cylindrical shape (circular in top view), and FIG. 1 is diagrammatically a vertical sectional view. The keg 1 is provided with a pipe 2 passing through the upper wall of the keg. One end of the pipe 2 is connected to a tap 3 having a handle 4 to open the tap 4, whereby beer can flow through the outflow pipe 5 of the tap. The other end of the pipe 2 is located near the bottom 6 of the keg 1.

Inside the keg 1 is a container 7 made of flexible plastic material, similar to a plastic bag. The container 7 can rest on the bottom 6 and the cylindrical side wall of the keg 1. The pipe 2 extends through an opening of the container 7, and the edge of that opening is connected to the outer side of the pipe 2, so that a liquid-tight sealing around the pipe 2 is obtained. The container 7 is sufficiently large to occupy the major part of the space inside the keg 1, and is filled with beer 9. At the lower side of the keg 1 is a cooling device 10 for cooling the beer in the container 7. Furthermore, a pump 11 is represented in FIG. 1 for pumping air into the keg 1 through valve 12, in order to drive the beer 9 out of the container 7.

When the container 7 is completely filled with beer 9, it will rest against the bottom 6 and the side wall of the keg 1. Then, only a little quantity of pressurized air is in the higher part of the keg 1 above the container 7, in order to keep the beer 9 at the require pressure. The beer 9 in the container 7 can be maintained at the desired drinking temperature by means of the cooling device 10, for example a Peltier cooling element, which is a known device. In order to dispense beer through the pipe 2 and the outflow pipe 5, the tap 3 can be opened by means of handle 4, whereby the pump 11 is switched on and valve 12 is opened, so that the air pressure above and/or around the container 7 is maintained, while the beer is flowing out of the keg 1.

FIG. 1 represents only the principle of a known beer dispensing device. The dispensing device can be an apparatus in which a keg 1 can be placed, whereby the tap 3, the outflow pipe 5, the cooling device 10, and the pump 11 are parts of the dispensing apparatus, and whereby the keg 1, including the pipe 2 and the container 7, is located inside the dispensing apparatus, and can be replaced after the container 7 is emptied. The parts as represented in FIG. 1 can also be incorporated in one device, which device has to be returned to a filling station for refilling the container 7 with beer 9, after the container 7 is emptied.

The flexible material of the container 7 is plastic, and therefore, the wall of the container 7 is not completely gas-tight. So, air can pass through the material and therefore the beer 9 can only be stored for a limited time in the container 7. Appropriate gas-tight sheet material having the required flexibility and other properties is not available for an acceptable cost price.

FIGS. 2A and 2B show the principle of a container 8 for containing pressurized beer, which container can be enveloped in a keg (not represented in FIGS. 2A and 2B). The container 8 has two rectangular rigid walls 13,14 (only the upper rigid wall 13 is visible in the figures) and between these two rigid walls 13,14 is a bellows 15, so that the distance between the two rigid walls 13,14 can vary. The bellows 15 forms the side wall of the container 8 and is folded in a zig-zag fashion, a so called accordion fold.

FIG. 2A shows the container 8 having its largest content, and FIG. 2B shows the container 8 whereby the tap 3 is opened and the beer is flowing out of the container 8, so that the two rigid walls 13,14 are moving to each other, resulting in a smaller content of the container 8. Thereby, the shape of the bellows 15 alters in a known manner.

The pipe 2 for guiding the beer out of the container 8 can be fixed to the upper rigid wall 13. The pipe 2 can also be fixed to the lower rigid wall 14, whereby the pipe 2 extends through an opening in the upper rigid wall 13. Thereby, the upper rigid wall 13 can move in axial direction along the outer surface of the pipe 2 and a sealing between the pipe and the upper rigid wall 13 prevents leakage of the beer between the pipe 2 and the upper rigid wall 13. The beer can enter the pipe 2 through one or more openings inside the container 8, near the lower rigid wall 14.

The elasticity of the bellows 15, together with its shape, can provide for a pulling force on the two rigid walls 13,14, so that the two rigid walls 13,14 are pulled towards each other by the bellows 15. Such force results in a pressure in the container 8 when it is filled with beer, i.e. when the two rigid walls 13,14 are positioned away from each other. The force can drive the beer out of the container 8 when the tap 3 is opened, or it can be an additional driving means. In order to increase the pressure in the container 8, also pulling springs can be present inside the container 8 between the two rigid walls 13,14.

The material of the container 8 can be relative thick, i.e. much thicker then the material of the container 7 of the described prior art, and the material can be metal or can comprise a metal layer, so that the container 8 is completely gas-tight.

The two rigid walls 13,14 of the container 8 can be rectangular, as is shown in FIGS. 2A and 2B, but they can also have any other shape, for example the shape of a circular disc or the shape of an equilateral polygon. Thereby, the bellows 15 has a corresponding shape. Furthermore, FIGS. 2A and 2B show the container whereby the two rigid walls 13,14 are substantially parallel with respect to each other. However, the two rigid walls 13,14 may also be mutually connected along one of their straight edges, so that the two walls 13,14 can hinge with respect to each other. Thereby, the bellows 15 is attached to the other edges of the two rigid walls 13,14.

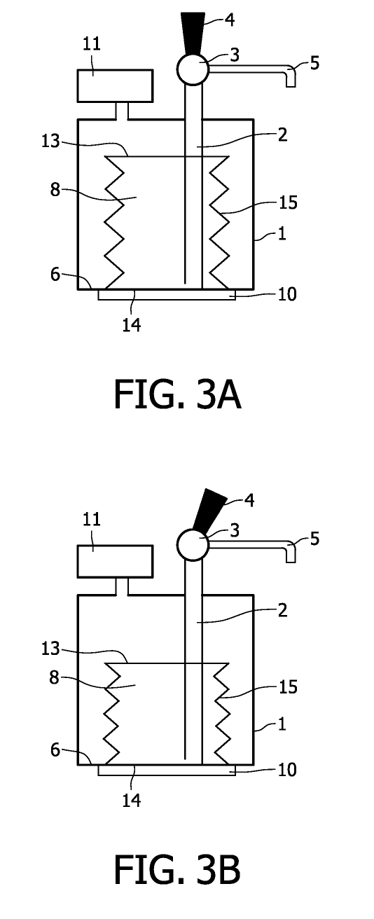

FIGS. 3A and 3B show the first embodiment of the keg 1 enveloping the container 8 according to FIG. 2. The container 8 is fixed on the bottom 6 of the keg 1 and a pump 11 is present for pumping air into the keg 1. The air pressure in the keg 1, for example a pressure of 1.5 bar, drives the beer out of the container 8 when the pump 11 is switched on and the tap 3 is opened, as is shown in FIG. 3B. Instead of air, also another gas or a liquid can be pumped into the keg 1 in order to drive the beer out of the container 8.

Like in all described embodiments, the pipe 2 may be made of rigid material, such as metal, whereby the pipe 2 passes through an opening in the rigid wall 13 of the container 8, and extends into the container 8 as is shown in the figures. Thereby, the opening in the rigid wall 13 can slide along the pipe 2, whereby a sealing ring provides for a gas-tight sealing. However, the pipe 2 may also be made of flexible material, whereby the end of the pipe 2 is connected to the opening in the rigid wall 13, and whereby the pipe does not extend into the container 8.

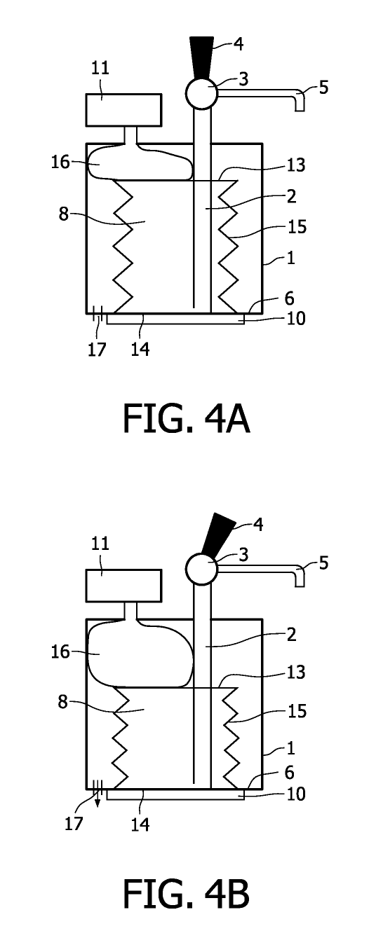

FIGS. 4A and 4B show the second embodiment of the keg 1 enveloping the container 8, whereby the beer can be driven out of the container 8 by means of a flexible bag 16. Therefore, gas or liquid is pumped by means of the pump 11 into the flexible bag 16, and the bag 16 pushes the rigid wall 13 downwards. Thereby, air can escape out of the keg 1, or enter into the keg, through an air vent 17 in the lower wall 6 of the keg 1.

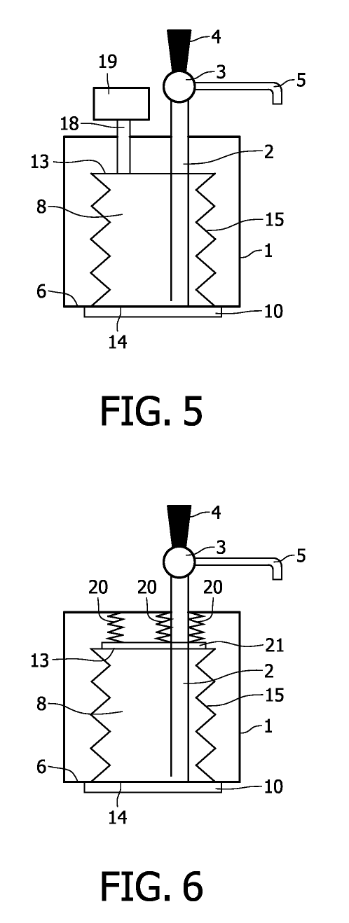

FIG. 5 shows the third embodiment, whereby the rigid wall 13 is pushed downwardly by means of a spindle 18, which spindle 18 is driven by a motor 19. The spindle 18 can move the rigid wall 13 in a controlled manner, so that the outflow of the beer through the tap 3 can be controlled. Furthermore, the position of the spindle 18 is known, which position is an indication of the quantity of the beer in the container 8, which quantity can, for example, be shown on the outside of the keg 1. A pressure sensor can be used in a feed-back system in order to control the pressure of the beer, whereby too high pressures of the beer can be avoided.

FIG. 6 shows the fourth embodiment, whereby the force for driving out the beer is obtained by means of a number of pushing helical springs 20. The springs 20 are present between the upper wall of the keg 1 and a plate 21, which plate 21 is connected to the rigid wall 13 of the container 8, so that the rigid wall 13 is pushed downwards. Springs can also be present underneath the container 8, between the lower wall 6 of the keg 1 and the rigid wall 14 of the container 8. Pre-loading of the springs 20 takes place during the filling operation of the container 8.

The four embodiments as described above are only examples of a keg according to the invention; many other embodiments are possible. For example, the two rigid walls of the container can be positioned vertical, whereby one or both of the rigid walls move in substantial horizontal direction.

1. A keg enveloping a container for containing a beverage and means for deforming the container in order to drive the beverage out of the keg, characterized in that the container comprises two substantial rigid walls, which walls are mutually connected by a flexible wall, whereby the flexible wall is shaped as a bellows, and whereby said means can move the two rigid walls towards each other, so that the distance between the two rigid walls varies.

2. A keg as claimed in claim 1, characterized in that the material of the container comprises a metal layer

3. A keg as claimed in claim 2, characterized in that the material of the container is metal.

4. A keg as claimed in claim 1, characterized in that the maximum distance between the two rigid walls is at least ten times, preferably more than fifteen times, the minimum distance between the rigid walls.

5. A keg as claimed in claim 1, characterized in that the two rigid walls are pulled towards each other by means of the elasticity of the material of the flexible wall.

6. A keg as claimed in claim 1, characterized in that the two rigid walls are substantial parallel.

7. A keg as claimed in claim 1, characterized in that, in sectional view, the flexible wall has substantially the shape of an equilateral polygon.

8. A keg as claimed in claim 1, characterized in that inside the keg, but outside the container, is a flexible container for containing a medium, which medium container can be pressurized in order to push the two rigid walls towards each other.

9. A keg as claimed in claim 1, characterized by mechanical means inside the keg for moving the two rigid walls towards each other.

10. A keg as claimed in claim 9, characterized in that the mechanical means comprise springs.
